(19) United States
(12) Patent Application Publication
(10) Pub. No.: US 2018/0178614 A1
(43) Pub. Date: Jun. 28, 2018

(54) AIRFLOW CONTROL SYSTEM OF A WORK VEHICLE

(71) Applicant: CNH Industrial America LLC, New Holland, PA (US)

(72) Inventors: Doriano Ferri, Brussels (BE); Jigarkumar N. Patel, West Chicago, IL (US); Tom Thierry Marc Peter Arsène Devriese, Veldegem (BE); John Edward Burnham, Batavia, IL (US)

(21) Appl. No.: 15/391,178

(22) Filed: Dec. 27, 2016

(51) Int. Cl. B60H 1/00; B60H 1/22

(52) U.S. Cl. CPC B60H 1/0075; B60H 1/22; B60H 1/00764; B60H 1/00378

(57) ABSTRACT

An airflow control system of a work vehicle includes a front vent assembly and a front blower configured to provide a front airflow to the front vent assembly. In addition, the airflow control system includes a rear vent assembly and a rear blower configured to provide a rear airflow to the rear vent assembly. Furthermore, the airflow control system includes an air distribution system fluidly coupled to the front blower and to the rear blower. The airflow control system also includes a sensor configured to output a signal indicative of a position of the sun relative to the work vehicle. In addition, the airflow control system includes a controller communicatively coupled to the front blower, the rear blower, and the sensor. The controller is configured to control the front blower and the rear blower based at least in part on the signal.

### BACKGROUND

The present disclosure relates generally to an airflow control system of a work vehicle.

Certain work vehicles (e.g., tractors, harvesters, skid steers, etc.) include a heating, ventilation, and air condition (HVAC) system configured to control an airflow into a cab of the work vehicle. Typical HVAC systems include a cooling system configured to reduce the air temperature within an interior of the cab (e.g., during warmer months). Furthermore, certain cabs include large transparent panels (e.g., glass panels) positioned around the vehicle occupant to enhance visibility. Unfortunately, the transparent panels enable solar radiation to pass through the cab, thereby warming the vehicle occupant. For example, if the sun is positioned to the right of the vehicle occupant, the solar radiation may warm the right side of the vehicle occupant. If the occupant manually increases the output of cool air from the HVAC system (e.g., by increasing a capacity of a blower), the left side, the front side, and the rear side of the occupant may become cooler than desired. And, if the occupant takes no action, the right side of the occupant may become warmer than desired. As a result, the comfort of the occupant may be reduced, regardless of whether the occupant adjusts the output of cool air from the HVAC system.

### BRIEF DESCRIPTION

In one embodiment, an airflow control system of a work vehicle includes a first front vent assembly configured to direct a first front airflow toward a front side of an occupant region of a cab of the work vehicle. The airflow control system also includes a first front blower configured to provide the first front airflow to the first front vent assembly. In addition, the airflow control system includes a rear vent assembly configured to direct a rear airflow toward a rear side of the occupant region of the cab of the work vehicle. The airflow control system also includes a rear blower configured to provide the rear airflow to the rear vent assembly. Furthermore, the airflow control system includes an air distribution system fluidly coupled to the first front blower and to the rear blower. The air distribution system is configured to receive an input airflow from an inlet to the air distribution system and to direct the input airflow to the first front blower and to the rear blower. The airflow control system also includes at least one sensor configured to output at least one signal indicative of a position of the sun relative to the work vehicle. In addition, the airflow control system includes a controller communicatively coupled to the first front blower, the rear blower, and the at least one sensor. The controller is configured to control the first front blower and the rear blower based at least in part on the at least one signal.

In another embodiment, an airflow control system of a work vehicle includes a first front vent assembly configured to direct a first front airflow toward a front side of an occupant region of a cab of the work vehicle. The airflow control system also includes a first front valve fluidly coupled to the first front vent assembly. The first front valve is configured to control the first front airflow through the first front vent assembly. In addition, the airflow control system includes a rear vent assembly configured to direct a rear airflow toward a rear side of the occupant region of the cab of the work vehicle. The airflow control system also includes a rear valve fluidly coupled to the rear vent assembly. The rear valve is configured to control the rear airflow through the rear vent assembly. Furthermore, the airflow control system includes an air distribution system fluidly coupled to the first front valve and to the rear valve. The air distribution system is configured to receive an input airflow from an inlet to the air distribution system and to direct the input airflow to the first front valve and to the rear valve. The airflow control system also includes at least one sensor configured to output at least one signal indicative of a position of the sun relative to the work vehicle. In addition, the airflow control system includes a controller communicatively coupled to the first front valve, the rear valve, and the at least one sensor. The controller is configured to control the first front valve and the rear valve based at least in part on the at least one signal.

In a further embodiment, an airflow control system of a work vehicle includes a first front vent assembly configured to direct a first front airflow toward a front side of an occupant region of a cab of the work vehicle. The airflow control system also includes a first front blower configured to receive an input airflow and to provide the first front airflow to the first front vent assembly. In addition, the airflow control system includes a rear vent assembly configured to direct a rear airflow toward a rear side of the occupant region of the cab of the work vehicle. The airflow control system also includes a rear blower configured to receive the input airflow and to provide the rear airflow to the rear vent assembly. Furthermore, the airflow control system includes an airflow control assembly configured to control a flow rate of external air from an external environment into the input airflow by adjusting a position of a door that controls mixing of the external air and recirculated air from an interior of the cab. The airflow control system also includes at least one sensor configured to output at least one signal indicative of a position of the sun relative to the work vehicle. In addition, the airflow control system includes a controller communicatively coupled to the airflow control assembly, the first front blower, the rear blower, and the at least one sensor. The controller is configured to control the first front blower and the rear blower based at least in part on the at least one signal, and the controller is configured to instruct the airflow control assembly to control the position of the door to substantially maintain the flow rate of the external air into the input airflow while the controller controls the first front blower and the rear blower based at least in part on the at least one signal.

### DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of a work vehicle that may include an airflow control system;

FIG. 2 is a schematic diagram of an embodiment of an airflow control system that may be employed within the work vehicle of FIG. 1;

FIG. 3 is a schematic diagram of an alternative embodiment of an airflow control system that may be employed within the work vehicle of FIG. 1;

FIG. 4 is a schematic diagram of an embodiment of a cab that may be employed within the work vehicle of FIG. 1, in which a front side of the cab is oriented toward the sun;

FIG. 5 is a schematic diagram of the cab of FIG. 4, in which a rear side of the cab is oriented toward the sun;

FIG. 6 is a schematic diagram of the cab of FIG. 4, in which a right side of the cab is oriented toward the sun; and

FIG. 7 is a schematic diagram of the cab of FIG. 4, in which a left side of the cab is oriented toward the sun.

### DETAILED DESCRIPTION

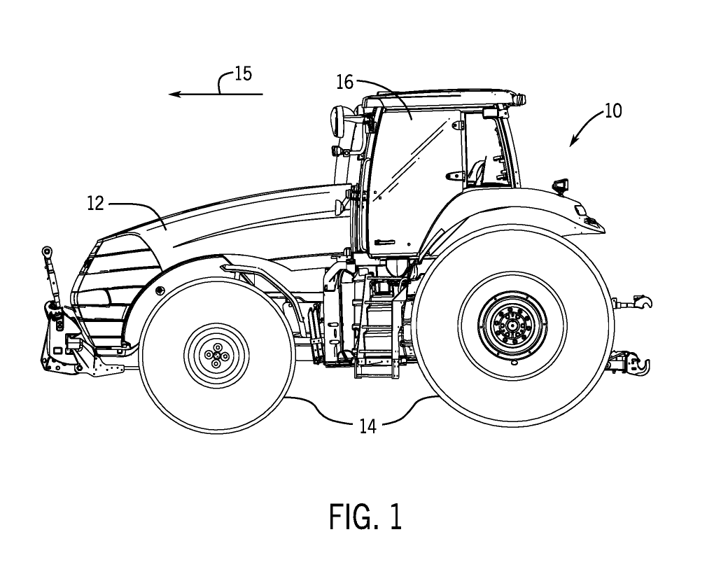

Turn now to the drawings, FIG. 1 is a side view of an embodiment of a work vehicle 10 that may include an airflow control system. In the illustrated embodiment, the work vehicle 10 includes a body 12 configured to house an engine, a transmission, other systems of the work vehicle 10, or a combination thereof. In addition, the work vehicle 10 includes wheels 14 configured to be driven by the engine and transmission, thereby driving the work vehicle 10 along a field, a road, or any other suitable surface in a direction of travel 15. In the illustrated embodiment, the work vehicle 10 includes a cab 16 configured to house an operator. As discussed in detail below, the work vehicle may include a heating, ventilation, and air conditioning (HVAC) system configured to control an air temperature within the cab and/or to pressurize the cab. Pressurizing the cab may substantially reduce ingress of dirt and/or other contaminants, enhance passenger comfort, reduce noise, or a combination thereof. In certain embodiments, the HVAC system includes an airflow control system configured to control airflow from multiple vent assemblies within an interior of the cab to compensate for solar heating. For example, airflow from one or more vent assemblies on a side of the cab facing the sun may be increased, thereby increasing cooling on a side of the occupant that is heated by solar radiation. As a result, occupant comfort may be enhanced. While the illustrated work vehicle 10 is a tractor, it should be appreciated that the airflow control system described herein may be employed within any other suitable type of work vehicle, such as a harvester, a sprayer, or a skid steer, among others.

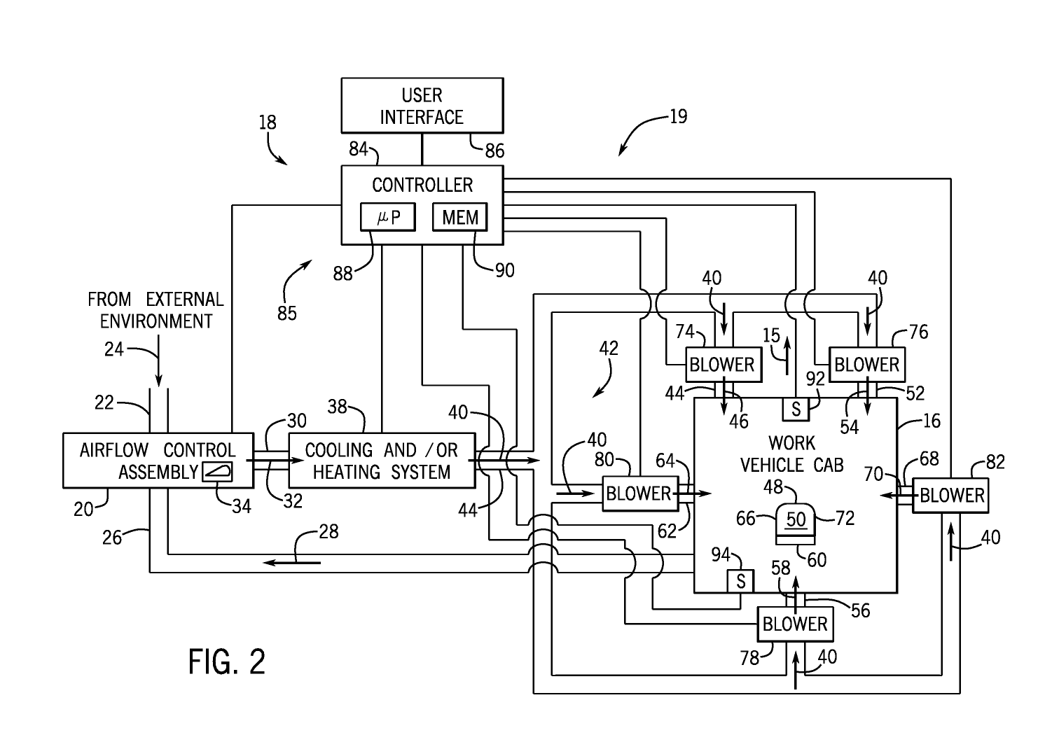

FIG. 2 is a schematic diagram of an embodiment of an HVAC system 18 that may be employed within the work vehicle of FIG. 1. In the illustrated embodiment, the HVAC system 18 includes an airflow control system 19 configured to control airflow into an interior of the work vehicle cab 16. The airflow control system 19 includes an airflow control assembly 20 configured to control mixing of air from an environment external to the cab (e.g., the external environment) and air recirculated from the cab. The airflow control assembly 20 includes a body having a first inlet 22 configured to receive an input airflow 24 from the external environment, and a second inlet 26 configured to receive a recirculation airflow 28 from the interior of the cab 16. The body of the airflow control assembly 20 also includes an outlet 30 configured to output an output airflow 32 toward the interior of the cab 16. In certain embodiments, the airflow control assembly includes a door 33 disposed within the body and configured to move (e.g., rotate) relative to the body to control the input airflow through the first inlet and the recirculation airflow through the second inlet, thereby controlling mixing of the external air and the recirculated air. For example, while the door is in a first position, the recirculation airflow 28 may be substantially blocked, such that the output airflow 32 includes mostly air from the external environment (e.g., more than 95 percent, more than 97 percent, more than 98 percent, more than 99 percent, more than 99.5 percent, etc.). In addition, while the door is in a second position, the input airflow 24 may be substantially blocked, such that the output airflow 32 includes mostly recirculated air (e.g., more than 95 percent, more than 97 percent, more than 98 percent, more than 99 percent, more than 99.5 percent, etc.). And, while the door is in a position between the first and second positions, the output airflow 32 may include a mixture of air from the external environment and recirculated air.

In the illustrated embodiment, the HVAC system 18 includes a cooling and/or heating system 38 configured to receive the airflow control assembly output airflow 32 and to output a cooled and/or heated airflow 40 having a higher or lower temperature than the airflow control assembly output airflow 32. As illustrated, the cooled and/or heated airflow 40 flows into an air distribution system 42 via an inlet 44 to the air distribution system. During certain operating conditions, the cooling and/or heating system 38 may be deactivated. As a result, the temperature of the airflow 40 may be substantially equal to the airflow control assembly output airflow 32. The cooling and/or heating system 38 may include a heater core of a heating system and/or an evaporator of a refrigeration system, among other heating and/or cooling devices/systems. In certain embodiments, the cooling and/or heating system may be omitted, and the airflow control assembly output airflow may flow directly into the air distribution system 42.

In the illustrated embodiment, the airflow control system 19 includes a first front vent assembly 44 configured to direct a first front airflow 46 toward a front side 48 of an occupant region 50 within the work vehicle cab 16. In addition, the airflow control system 19 includes a second front vent assembly 52 configured to direct a second front airflow 54 toward the front side 48 of the occupant region 50. The airflow control system 19 also includes a rear vent assembly 56 configured to direct a rear airflow 58 toward a rear side 60 of the occupant region 50. Furthermore, the airflow control system 19 includes a left vent assembly 62 configured to direct a left airflow 64 toward a left side 66 of the occupant region 50. The airflow control system 19 also includes a right vent assembly 68 configured to direct a right airflow 70 toward a right side 72 of the occupant region 50. Each of the vent assemblies may include one vent or multiple vents (e.g., spaced apart from one another within the interior of the work vehicle cab). In addition, certain vent(s) of the vent assemblies may include adjustable flap(s) to control an output direction of the respective airflow(s). In the illustrated embodiment, the occupant region 50 corresponds to an occupant seat within the interior of the cab 16. However, it should be appreciated that in alternative embodiments, the occupant region may correspond to any suitable location where the occupant may be positioned.

In the illustrated embodiment, the airflow control system 19 includes a first front blower 74 configured to receive the cooled and/or heated airflow 40 (e.g., input airflow) and to provide the first front airflow 46 to the first front vent assembly 44. In addition, the airflow control system 19 includes a second front blower 76 configured to receive the input airflow 40 and to provide the second front airflow 54 to the second front vent assembly 52. The airflow control system 19 also includes a rear blower 78 configured to receive the input airflow 40 and to provide the rear airflow 58 to the rear vent assembly 56. Furthermore, the airflow control system 19 includes a left blower 80 configured to receive the input airflow 40 and to provide the left airflow 64 to the left vent assembly 62. The airflow control system 19 also includes a right blower 82 configured to receive the input airflow 40 and to provide the right airflow 70 to the right vent assembly 68. In the illustrated embodiment, the air distribution system 42 is fluidly coupled to the first front blower 74, to the second front blower 76, to the rear blower 78, to the left blower 80, and to the right blower 82. The air distribution system 42 is configured to receive the input airflow 40 from the inlet 44 and to direct the input airflow to each of the blowers (e.g., via a network of conduits). Accordingly, each of the blowers receives the input airflow from a common source (e.g., the inlet 44 of the air distribution system 42).

While the illustrated embodiment includes two front vent assemblies and two front blowers, it should be appreciated that in alternative embodiments, the airflow control system may include more of fewer front vent assemblies/blowers. For example, in certain embodiments, the airflow control system may include a single front vent assembly (e.g., having multiple vents) and a single front blower. In further embodiments, the airflow control system may include 3, 4, 5, 6, or more front vent assemblies and a corresponding number of front blowers. Furthermore, while the illustrated embodiment includes a single rear vent assembly and a single rear blower, it should be appreciated that in alternative embodiments, the airflow control system may include more rear vent assemblies/blowers (e.g., 2, 3, 4, 5, 6, or more). In addition, while the illustrated embodiment includes a single left vent assembly and a single left blower, it should be appreciated that in alternative embodiments, the airflow control system may include more or fewer left vent assemblies/blowers (e.g., 0, 1, 2, 3, 4, 5, 6, or more). While the illustrated embodiment includes a single right vent assembly and a single right blower, it should be appreciated that in alternative embodiments, the airflow control system may include more or fewer right vent assemblies/blowers (e.g., 0, 1, 2, 3, 4, 5, 6, or more).

In the illustrated embodiment, the airflow control system 19 includes a controller 84, which may be an element of an automatic temperature control system 85, communicatively coupled to the airflow control assembly 20, the cooling and/or heating system 38, the first front blower 74, the second front blower 76, the rear blower 78, the left blower 80, and the right blower 82. The controller 84 may be configured to instruct an actuator of the airflow control assembly to control the position of the door, thereby controlling the mixing of the external air and the recirculated air. In addition, the controller may be configured to control the capacity of each blower, thereby controlling the flow rate of each respective airflow into the interior of the work vehicle cab. The controller may also be configured to control the cooling and/or heating system to control the temperature of the airflow into the interior of the cab. In the illustrated embodiment, the controller 84 is communicatively coupled to a user interface 86. The user interface 86 may be located within the cab of the work vehicle and configured to receive input from the operator, such as input for controlling the airflow control assembly, the blowers, the cooling and/or heating system, or a combination thereof.

In certain embodiments, the controller 84 is an electronic controller having electrical circuitry configured to process data from certain components of the HVAC system 18, such as the user interface 86. The controller 84 includes a processor, such as the illustrated microprocessor 88, and a memory device 90. The controller 84 may also include one or more storage devices and/or other suitable components. The processor 88 may be used to execute software, such as software for controlling the airflow control system, the blowers, and so forth. Moreover, the processor 88 may include multiple microprocessors, one or more “general-purpose” microprocessors, one or more special-purpose microprocessors, and/or one or more application specific integrated circuits (ASICS), or some combination thereof. For example, the processor 88 may include one or more reduced instruction set (RISC) processors.

The memory device 90 may include a volatile memory, such as random access memory (RAM), and/or a nonvolatile memory, such as read-only memory (ROM). The memory device 90 may store a variety of information and may be used for various purposes. For example, the memory device 90 may store processor-executable instructions (e.g., firmware or software) for the processor 88 to execute, such as instructions for controlling the airflow control system, the blowers, and so forth. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling the airflow control system, etc.), and any other suitable data.

In the illustrated embodiment, the airflow control system 19 includes a first sensor 92 positioned forward of the front side 48 of the occupant region 50 relative to the direction of travel 15. The first sensor 92 is configured to output a first signal indicative of a position of the sun relative to the work vehicle. In addition, the airflow control system 19 includes a second sensor 94 positioned rearward of the rear side 60 of the occupant region 50 relative to the direction of travel 15. The second sensor 94 is configured to output a second signal indicative of the position of the sun relative to the work vehicle. The first sensor may be configured to monitor the position of the sun while the sun is positioned forward of the work vehicle (e.g., while the occupant region blocks the second sensor), and the second sensor may be configured to monitor the position of the sun while the sun is positioned rearward of the work vehicle (e.g., while the occupant region blocks the first sensor). While the illustrated embodiment includes two sensors, it should be appreciated that in alternative embodiments, the airflow control system may include more or fewer sensors. For example, in certain embodiments, the first sensor or the second sensor may be omitted. In further embodiments, the airflow control system may include a sensor positioned to the left of the occupant region and/or a sensor positioned to the right of the occupant region, and/or another sensor positioned in another suitable location on the work vehicle.

In certain embodiments, each sensor may be configured to detect radiation (e.g., visible light, infrared light, etc.) emitted by the sun and to output a signal indicative of the position of the sun relative to the work vehicle. For example, in certain embodiments, each of the first and second sensors may be configured to output a respective signal indicative of a magnitude of the detected solar radiation. In such embodiments, the controller may be configured to compare the signals to determine whether the sun is position forward of the work vehicle or rearward of the work vehicle relative to the direction of travel. Furthermore, certain embodiments may include left and right sensors, each configured to output a respective signal indicative of a magnitude of the detected solar radiation. In such embodiments, the controller may be configured to compare the signals from the first sensor, the second sensor, the left sensor, and the right sensor to determine the position of the sun relative to the work vehicle. In further embodiments, the first sensor and/or the second sensor may be configured to output a signal indicative of the direction of the sun relative to the work vehicle. In such embodiments, the controller may be configured to determine the position of the sun relative to the work vehicle based on the signal from a single sensor (e.g., the front sensor if the sun is position forward of the work vehicle, or the rear sensor if the sun is positioned rearward of the work vehicle).

In the illustrated embodiment, the controller 84 is configured to control the blowers (e.g., the capacity of each blower) based at least in part on the signal(s) from the sensor(s). For example, the controller may be configured to instruct the first front blower and/or the second front blower to increase capacity while the sun is positioned on a front side of the work vehicle relative to the direction of travel. The increased airflow from the front blower(s) may compensate for the solar heating on the front side of the vehicle occupant (e.g., resulting from the solar radiation), thereby enhancing occupant comfort. In certain embodiments, the controller may also be configured to instruct at least one of the other blowers (e.g., the rear blower, the left blower, the right blower, or a combination thereof) to decrease capacity, thereby maintaining the total airflow rate into the interior of the cab. In further embodiments, the controller may be configured to instruct the airflow control assembly to control the position of the door to substantially maintain the flow rate of external air into the air distribution system and, thus, into the interior of the cab. The controller may also be configured to instruct the other blower(s) to reduce capacity and instruct the airflow control assembly to control the position of the door to substantially maintain the flow rate of the external air and/or the total airflow rate into the interior of the cab.

By way of further example, the controller may be configured to instruct the rear blower to increase capacity while the sun is positioned on a rear side of the work vehicle relative to the direction of travel. The increased airflow from the rear blower may compensate for the solar heating on the rear side of the vehicle occupant (e.g., resulting from the solar radiation), thereby enhancing occupant comfort. In certain embodiments, the controller may also be configured to instruct at least one of the other blowers (e.g., the first front blower, the second front blower, the left blower, the right blower, or a combination thereof) to decrease capacity, thereby maintaining the total airflow rate into the interior of the cab. In further embodiments, the controller may be configured to instruct the airflow control assembly to control the position of the door to substantially maintain the flow rate of external air into the air distribution system and, thus, into the interior of the cab. The controller may also be configured to instruct the other blower(s) to reduce capacity and instruct the airflow control assembly to control the position of the door to substantially maintain the flow rate of the external air and/or the total airflow rate into the interior of the cab.

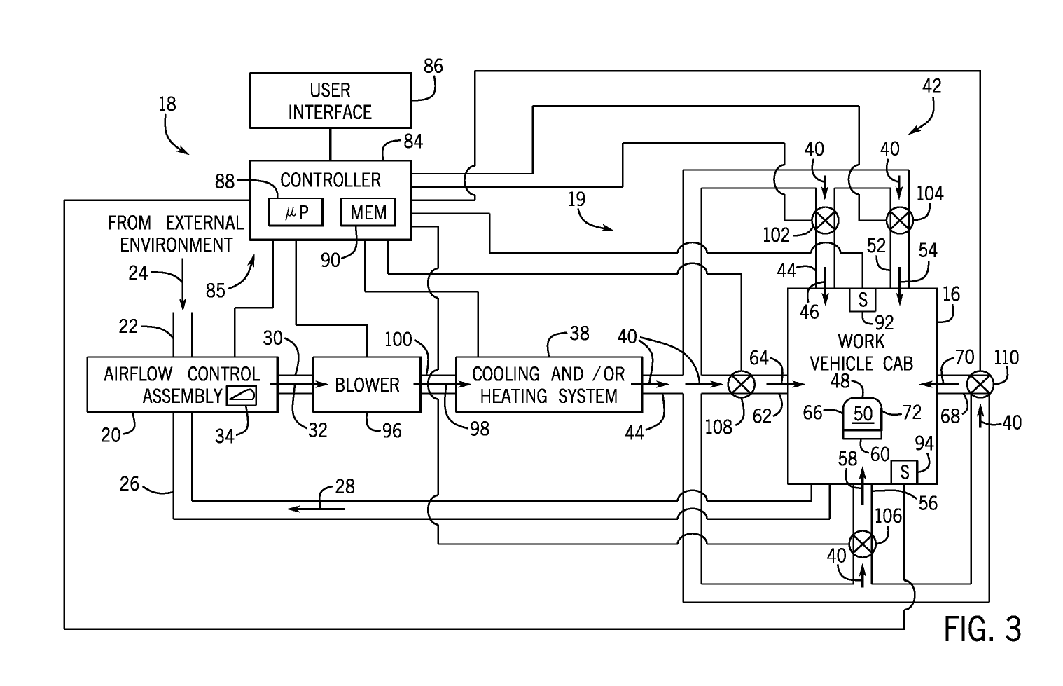

FIG. 3 is a schematic diagram of an alternative embodiment of an airflow control system 19 that may be employed within the work vehicle of FIG. 1. In the illustrated embodiment, the airflow control system 19 includes a blower 96 fluidly disposed between the airflow control assembly 20 and the cooling and/or heating system 38. The blower 96 is configured to receive the airflow control assembly output airflow 32 and to provide a blower output airflow 98 to the cooling and/or heating system 38 via an outlet 100. Similar to the embodiment described above with reference to FIG. 2, the cooling and/or heating system 38 outputs a cooled and/or heated airflow 40 (e.g., input airflow) to the air distribution system 42 via the inlet 44 of the air distribution system 42.

In the illustrated embodiment, multiples valves are fluidly disposed between the air distribution system 42 and respective vent assemblies. The air distribution system is configured to distribute the input airflow 40 from the inlet to each of the respective valves. As illustrated, a first front valve 102 is fluidly coupled to the first front vent assembly 44, and the first front valve 102 is configured to control the first front airflow 46 through the first front vent assembly 44. In addition, a second front valve 104 is fluidly coupled to the second front vent assembly 52, and the second front valve 104 is configured to control the second front airflow 54 through the second front vent assembly 52. Furthermore, a rear valve 106 is fluidly coupled to the rear vent assembly 56, and the rear valve 106 is configured to control the rear airflow 58 through the rear vent assembly 56. A left valve 108 is fluidly coupled to the left vent assembly 62, and the left valve 108 is configured to control the left airflow 64 through the left vent assembly 62. In addition, the right valve 110 is fluidly coupled to the right vent assembly 68, and the right valve 110 is configured to control the right airflow 70 through the right vent assembly 68.

While the illustrated embodiment includes two front vent assemblies and two front valves, it should be appreciated that in alternative embodiments, the airflow control system may include more of fewer front vent assemblies/valves. For example, in certain embodiments, the airflow control system may include a single front vent assembly (e.g., having multiple vents) and a single front valve. In further embodiments, the airflow control system may include 3, 4, 5, 6, or more front vent assemblies and a corresponding number of front valves. Furthermore, while the illustrated embodiment includes a single rear vent assembly and a single rear valve, it should be appreciated that in alternative embodiments, the airflow control system may include more rear vent assemblies/valves (e.g., 2, 3, 4, 5, 6, or more). In addition, while the illustrated embodiment includes a single left vent assembly and a single left valve, it should be appreciated that in alternative embodiments, the airflow control system may include more or fewer left vent assemblies/valves (e.g., 0, 1, 2, 3, 4, 5, 6, or more). While the illustrated embodiment includes a single right vent assembly and a single right valve, it should be appreciated that in alternative embodiments, the airflow control system may include more or fewer right vent assemblies/valves (e.g., 0, 1, 2, 3, 4, 5, 6, or more).

In the illustrated embodiment, the controller 84 is communicatively coupled to the blower 96, the first front valve 102, the second front valve 104, the rear valve 106, the left valve 108, and the right valve 110. The controller 84 is configured to control the valves based at least in part on the signal(s) from the sensor(s). For example, the controller may be communicatively coupled to an actuator (e.g., solenoid) of each valve and configured to instruct the actuator to control a position of the valve. In addition, the controller 84 may be configured to control the capacity of the blower 96 to control the total airflow rate into the interior of the work vehicle cab 16.

In certain embodiments, the controller may be configured to instruct the first front valve and/or the second front valve to increase the respective front airflow(s) while the sun is positioned on a front side of the work vehicle relative to the direction of travel. In further embodiments, the controller may be configured to instruct the other valve(s) (e.g., the rear valve, the left valve, the right valve, or a combination thereof) to decrease the respective airflow(s), thereby increasing the airflow(s) through the first front vent assembly and/or the second front vent assembly. The increased airflow from the first front vent assembly and/or the second front vent assembly may compensate for the solar heating on the front side of the vehicle occupant (e.g., resulting from the solar radiation), thereby enhancing occupant comfort. In certain embodiments, the controller may also be configured to control the blower (e.g., the capacity of the blower) to maintain the total airflow rate into the interior of the cab. For example, the controller may be configured to instruct the blower to decrease capacity if the first front valve and/or the second front valve is instructed to increase the respective front airflow(s), or the controller may be configured to instruct the blower to increase capacity if the other valve(s) are instructed to decrease the respective airflow(s). In further embodiments, the controller may be configured to instruct the airflow control assembly to control the position of the door to substantially maintain the flow rate of external air into the air distribution system and, thus, into the interior of the cab. The controller may also be configured to control the blower and the airflow control assembly to substantially maintain the flow rate of the external air and/or the total airflow rate into the interior of the cab.

Furthermore, in certain embodiments, the controller may be configured to instruct the rear valve to increase the rear airflow while the sun is positioned on a rear side of the work vehicle relative to the direction of travel. In further embodiments, the controller may be configured to instruct the other valve(s) (e.g., the first front valve, the second front valve, the left valve, the right valve, or a combination thereof) to decrease the respective airflow(s), thereby increasing the airflow through the rear vent assembly. The increased airflow from the rear vent assembly may compensate for the solar heating on the rear side of the vehicle occupant (e.g., resulting from the solar radiation), thereby enhancing occupant comfort. In certain embodiments, the controller may also be configured to control the blower (e.g., the capacity of the blower) to maintain the total airflow rate into the interior of the cab. For example, the controller may be configured to instruct the blower to decrease capacity if the rear valve is instructed to increase the rear airflow, or the controller may be configured to instruct the blower to increase capacity if the other valve(s) are instructed to decrease the respective airflow(s). In further embodiments, the controller may be configured to instruct the airflow control assembly to control the position of the door to substantially maintain the flow rate of external air into the air distribution system and, thus, into the interior of the cab. The controller may also be configured to control the blower and the airflow control assembly to substantially maintain the flow rate of the external air and/or the total airflow rate into the interior of the cab.

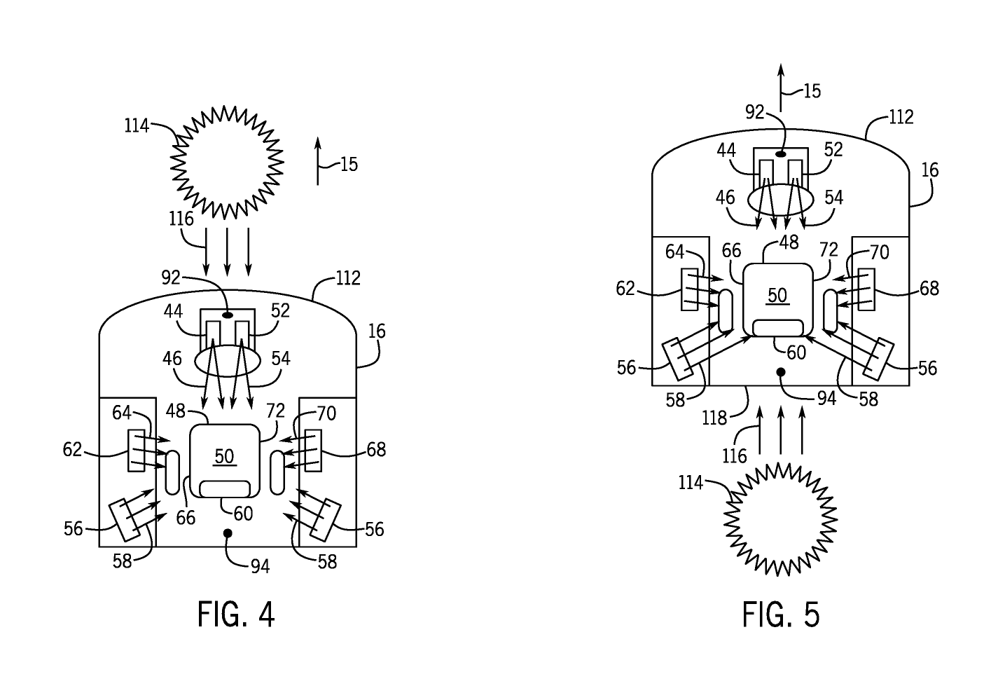

FIG. 4 is a schematic diagram of an embodiment of a cab 16 that may be employed within the work vehicle of FIG. 1, in which a front side 112 of the cab is oriented toward the sun 114. Accordingly, solar radiation 116 is directed toward the front side 48 of the occupant region 50. In embodiments including an independent blower for each vent assembly, the controller is configured to instruct the first front blower and/or the second front blower to increase capacity. The increased airflow from the front blower(s) may compensate for the solar heating on the front side of the vehicle occupant (e.g., resulting from the solar radiation 116), thereby enhancing occupant comfort. In certain embodiments, the controller may also be configured to instruct at least one of the other blowers (e.g., the rear blower, the left blower, the right blower, or a combination thereof) to decrease capacity, thereby maintaining the total airflow rate into the interior of the cab. In further embodiments, the controller may be configured to instruct the airflow control assembly to control the position of the door to substantially maintain the flow rate of external air into the air distribution system and, thus, into the interior of the cab. The controller may also be configured to instruct the other blower(s) to reduce capacity and instruct the airflow control assembly to control the position of the door to substantially maintain the flow rate of the external air and/or the total airflow rate into the interior of the cab.

In embodiments including a single blower and a valve for each vent assembly, the controller may be configured to instruct the first front valve and/or the second front valve to increase the respective front airflow(s). In further embodiments, the controller may be configured to instruct the other valve(s) (e.g., the rear valve, the left valve, the right valve, or a combination thereof) to decrease the respective airflow(s), thereby increasing the airflow(s) through the first front vent assembly and/or the second front vent assembly. The increased airflow(s) from the first front vent assembly 44 and/or the second front vent assembly 52 may compensate for the solar heating on the front side of the vehicle occupant (e.g., resulting from the solar radiation 116), thereby enhancing occupant comfort. In certain embodiments, the controller may also be configured to control the blower (e.g., the capacity of the blower) to maintain the total airflow rate into the interior of the cab. For example, the controller may be configured to instruct the blower to decrease capacity if the first front valve and/or the second front valve is instructed to increase the respective front airflow(s), or the controller may be configured to instruct the blower to increase capacity if the other valve(s) are instructed to decrease the respective airflow(s). In further embodiments, the controller may be configured to instruct the airflow control assembly to control the position of the door to substantially maintain the flow rate of external air into the air distribution system and, thus, into the interior of the cab. The controller may also be configured to control the blower and the airflow control assembly to substantially maintain the flow rate of the external air and/or the total airflow rate into the interior of the cab.

FIG. 5 is a schematic diagram of the cab 16 of FIG. 4, in which a rear side 118 of the cab 16 is oriented toward the sun 114. Accordingly, the solar radiation 116 is directed toward the rear side 60 of the occupant region 50. In embodiments including an independent blower for each vent assembly, the controller is configured to instruct the rear blower to increase capacity. The increased airflow from the rear blower may compensate for the solar heating on the rear side of the vehicle occupant (e.g., resulting from the solar radiation 116), thereby enhancing occupant comfort. In certain embodiments, the controller may also be configured to instruct at least one of the other blowers (e.g., the first front blower, the second front blower, the left blower, the right blower, or a combination thereof) to decrease capacity, thereby maintaining the total airflow rate into the interior of the cab. In further embodiments, the controller may be configured to instruct the airflow control assembly to control the position of the door to substantially maintain the flow rate of external air into the air distribution system and, thus, into the interior of the cab. The controller may also be configured to instruct the other blower(s) to reduce capacity and instruct the airflow control assembly to control the position of the door to substantially maintain the flow rate of the external air and/or the total airflow rate into the interior of the cab.

In embodiments including a single blower and a valve for each vent assembly, the controller may be configured to instruct the rear valve to increase the rear airflow. In further embodiments, the controller may be configured to instruct the other valve(s) (e.g., the first front valve, the second front valve, the left valve, the right valve, or a combination thereof) to decrease the respective airflow(s), thereby increasing the airflow through the rear vent assembly. The increased airflow from the rear vent assembly 56, which includes two vents in the illustrated embodiment, may compensate for the solar heating on the rear side of the vehicle occupant (e.g., resulting from the solar radiation 116), thereby enhancing occupant comfort. In certain embodiments, the controller may also be configured to control the blower (e.g., the capacity of the blower) to maintain the total airflow rate into the interior of the cab. For example, the controller may be configured to instruct the blower to decrease capacity if the rear valve is instructed to increase the rear airflow, or the controller may be configured to instruct the blower to increase capacity if the other valve(s) are instructed to decrease the respective airflow(s). In further embodiments, the controller may be configured to instruct the airflow control assembly to control the position of the door to substantially maintain the flow rate of external air into the air distribution system and, thus, into the interior of the cab. The controller may also be configured to control the blower and the airflow control assembly to substantially maintain the flow rate of the external air and/or the total airflow rate into the interior of the cab.

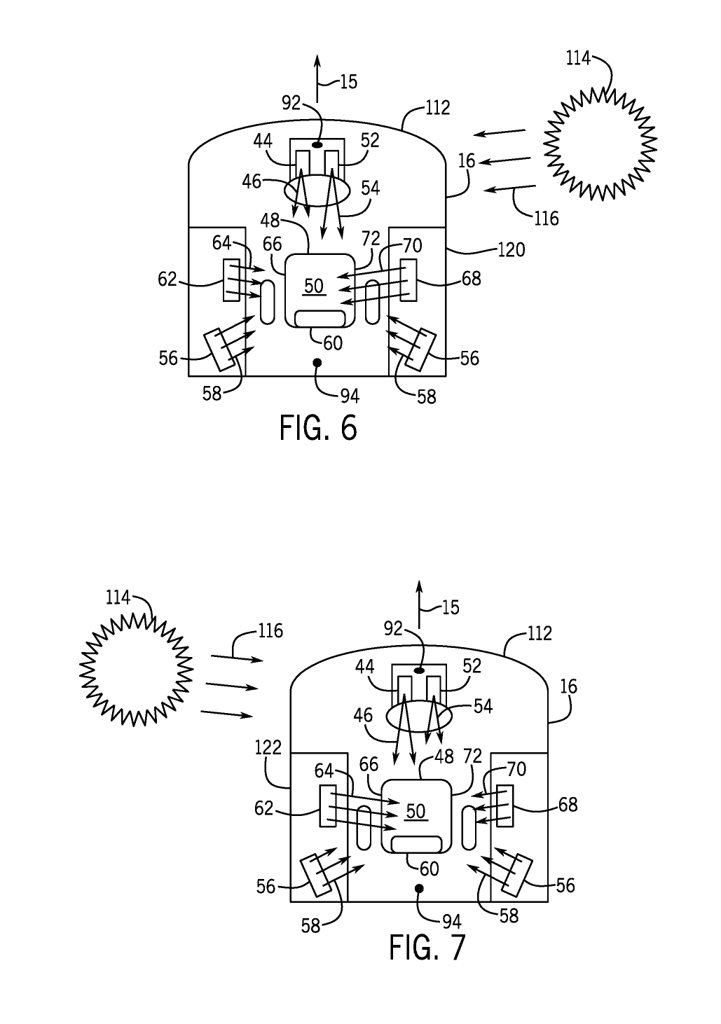

FIG. 6 is a schematic diagram of the cab 16 of FIG. 4, in which a right side 120 of the cab 16 is oriented toward the sun 114. Accordingly, the solar radiation 116 is directed toward the right side 72 of the occupant region 50. In embodiments including an independent blower for each vent assembly, the controller is configured to instruct the right blower and/or the second front blower to increase capacity. The increased airflow from the right blower and/or the second front blower may compensate for the solar heating on the right side of the vehicle occupant (e.g., resulting from the solar radiation 116), thereby enhancing occupant comfort. In certain embodiments, the controller may also be configured to instruct at least one of the other blowers (e.g., the first front blower, the left blower, the rear blower, or a combination thereof) to decrease capacity, thereby maintaining the total airflow rate into the interior of the cab. In further embodiments, the controller may be configured to instruct the airflow control assembly to control the position of the door to substantially maintain the flow rate of external air into the air distribution system and, thus, into the interior of the cab. The controller may also be configured to instruct the other blower(s) to reduce capacity and instruct the airflow control assembly to control the position of the door to substantially maintain the flow rate of the external air and/or the total airflow rate into the interior of the cab.

In embodiments including a single blower and a valve for each vent assembly, the controller may be configured to instruct the right valve to increase the right airflow and/or the second front valve to increase the second front airflow. In further embodiments, the controller may be configured to instruct the other valve(s) (e.g., the first front valve, the left valve, the rear valve, or a combination thereof) to decrease the respective airflow(s), thereby increasing the airflow(s) through the right vent assembly and/or the second front vent assembly. The increased airflow(s) from the right vent assembly 68 and/or the second front vent assembly 52 may compensate for the solar heating on the right side of the vehicle occupant (e.g., resulting from the solar radiation 116), thereby enhancing occupant comfort. In certain embodiments, the controller may also be configured to control the blower (e.g., the capacity of the blower) to maintain the total airflow rate into the interior of the cab. For example, the controller may be configured to instruct the blower to decrease capacity if the right valve and/or the second front valve is instructed to increase the respective airflow(s), or the controller may be configured to instruct the blower to increase capacity if the other valve(s) are instructed to decrease the respective airflow(s). In further embodiments, the controller may be configured to instruct the airflow control assembly to control the position of the door to substantially maintain the flow rate of external air into the air distribution system and, thus, into the interior of the cab. The controller may also be configured to control the blower and the airflow control assembly to substantially maintain the flow rate of the external air and/or the total airflow rate into the interior of the cab.

FIG. 7 is a schematic diagram of the cab 16 of FIG. 4, in which a left side 122 of the cab 16 is oriented toward the sun 114. Accordingly, the solar radiation 116 is directed toward the left side 66 of the occupant region 50. In embodiments including an independent blower for each vent assembly, the controller is configured to instruct the left blower and/or the first front blower to increase capacity. The increased airflow from the left blower and/or the first front blower may compensate for the solar heating on the left side of the vehicle occupant (e.g., resulting from the solar radiation 116), thereby enhancing occupant comfort. In certain embodiments, the controller may also be configured to instruct at least one of the other blowers (e.g., the second front blower, the right blower, the rear blower, or a combination thereof) to decrease capacity, thereby maintaining the total airflow rate into the interior of the cab. In further embodiments, the controller may be configured to instruct the airflow control assembly to control the position of the door to substantially maintain the flow rate of external air into the air distribution system and, thus, into the interior of the cab. The controller may also be configured to instruct the other blower(s) to reduce capacity and instruct the airflow control assembly to control the position of the door to substantially maintain the flow rate of the external air and/or the total airflow rate into the interior of the cab.

In embodiments including a single blower and a valve for each vent assembly, the controller is configured to instruct the left valve to increase the left airflow and/or the first front valve to increase the first front airflow. In further embodiments, the controller may be configured to instruct the other valve(s) (e.g., the second front valve, the right valve, the rear valve, or a combination thereof) to decrease the respective airflow(s), thereby increasing the airflow(s) through the left vent assembly and/or the first front vent assembly. The increased airflow(s) from the left vent assembly 68 and/or the first front vent assembly 52 may compensate for the solar heating on the left side of the vehicle occupant (e.g., resulting from the solar radiation 116), thereby enhancing occupant comfort. In certain embodiments, the controller may also be configured to control the blower (e.g., the capacity of the blower) to maintain the total airflow rate into the interior of the cab. For example, the controller may be configured to instruct the blower to decrease capacity if the left valve and/or the first front valve is instructed to increase the respective airflow(s), or the controller may be configured to instruct the blower to increase capacity if the other valve(s) are instructed to decrease the respective airflow(s). In further embodiments, the controller may be configured to instruct the airflow control assembly to control the position of the door to substantially maintain the flow rate of external air into the air distribution system and, thus, into the interior of the cab. The controller may also be configured to control the blower and the airflow control assembly to substantially maintain the flow rate of the external air and/or the total airflow rate into the interior of the cab.

The examples disclosed above with reference to FIGS. 2-7 relate to compensating for solar heating during warmer months. For example, within the examples disclosed above with reference to FIGS. 2-7, the cooling system may be activated and the heating system may be deactivated, such that chilled/cooled air is provided to the air distribution system. However, during moderate months, the cooling system and the heating system may be deactivated, and substantially ambient temperature air may be provided to the air distribution system. During colder months, the heating system may be activated and the cooling system may be deactivated. Accordingly, to compensate for solar heating on one side of the vehicle occupant, the airflow through the vent assembly/assemblies on the side of the work vehicle facing the sun may be reduced (e.g., by reducing certain blower capacity/capacities or by controlling certain valve(s)). In certain embodiments, the airflow through the other vent assemblies may be increased and/or the position of the door of the airflow control assembly may be controlled to substantially maintain the flow rate of the external air and/or the total airflow rate into the interior of the cab.

While only certain features have been illustrated and described herein, many modifications and changes will occur to those skilled in the art. It is, therefore, to be understood that the appended claims are intended to cover all such modifications and changes as fall within the true spirit of the disclosure.

1. An airflow control system of a work vehicle, comprising:
a first front vent assembly configured to direct a first front airflow toward a front side of an occupant region of a cab of the work vehicle;
a first front blower configured to provide the first front airflow to the first front vent assembly;
a rear vent assembly configured to direct a rear airflow toward a rear side of the occupant region of the cab of the work vehicle;
a rear blower configured to provide the rear airflow to the rear vent assembly;
an air distribution system fluidly coupled to the first front blower and to the rear blower, wherein the air distribution system is configured to receive an input airflow from an inlet to the air distribution system and to direct the input airflow to the first front blower and to the rear blower;
at least one sensor configured to output at least one signal indicative of a position of the sun relative to the work vehicle; and
a controller communicatively coupled to the first front blower, the rear blower, and the at least one sensor, wherein the controller is configured to control the first front blower and the rear blower based at least in part on the at least one signal.

2. The airflow control system of claim 1, wherein the at least one sensor comprises:
a front sensor positioned forward of the front side of the occupant region relative to a direction of travel of the work vehicle, wherein the front sensor is configured to output a first signal indicative of the position of the sun relative to the work vehicle; and
a rear sensor positioned rearward of the rear side of the occupant region relative to the direction of travel of the work vehicle, wherein the rear sensor is configured to output a second signal indicative of the position of the sun relative to the work vehicle.

3. The airflow control system of claim 1, comprising:
a second front vent assembly configured to direct a second front airflow toward the front side of the occupant region of the cab; and
a second front blower configured to provide the second front airflow to the second front vent assembly;
wherein the air distribution system is fluidly coupled to the second front blower, the air distribution system is configured to direct the input airflow from the inlet of the air distribution system to the second front blower, the controller is communicatively coupled to the second front blower, and the controller is configured to control the second front blower based at least in part on the at least one signal.

4. The airflow control system of claim 1, wherein the controller is configured to instruct the first front blower to increase capacity and to instruct the rear blower to decrease capacity while the sun is positioned on a front side of the work vehicle relative to a direction of travel of the work vehicle, and the controller is configured to instruct the first front blower to decrease capacity and to instruct the rear blower to increase capacity while the sun is positioned on a rear side of the work vehicle relative to the direction of travel.

5. The airflow control system of claim 1, comprising:
a left vent assembly configured to direct a left airflow toward a left side of the occupant region of the cab;
a left blower configured to provide the left airflow to the left vent assembly;
a right vent assembly configured to direct a right airflow toward a right side of the occupant region of the cab; and
a right blower configured to provide the right airflow to the right vent assembly;
wherein the air distribution system is fluidly coupled to the left blower and to the right blower, the air distribution system is configured to direct the input airflow from the inlet of the air distribution system to the left blower and to the right blower, the controller is communicatively coupled to the left blower and to the right blower, and the controller is configured to control the left blower and the right blower based at least in part on the at least one signal.

6. The airflow control system of claim 5, wherein the controller is configured to instruct the left blower to increase capacity and to instruct the right blower to decrease capacity while the sun is positioned on a left side of the work vehicle relative to a direction of travel of the work vehicle, and the controller is configured to instruct the left blower to decrease capacity and to instruct the right blower to increase capacity while the sun is positioned on a right side of the work vehicle relative to the direction of travel.

7. The airflow control system of claim 1, comprising an airflow control assembly fluidly coupled to the inlet of the air distribution system, wherein the airflow control assembly is configured to control mixing of external air from an external environment and recirculated air from the cab of the work vehicle based on a position of a door of the airflow control assembly, the controller is communicatively coupled to the airflow control assembly, and the controller is configured to instruct the airflow control assembly to control the position of the door to substantially maintain a flow rate of the external air into the air distribution system while the controller controls the first front blower and the rear blower based at least in part on the at least one signal.

8. An airflow control system of a work vehicle, comprising:
a first front vent assembly configured to direct a first front airflow toward a front side of an occupant region of a cab of the work vehicle;
a first front valve fluidly coupled to the first front vent assembly, wherein the first front valve is configured to control the first front airflow through the first front vent assembly;
a rear vent assembly configured to direct a rear airflow toward a rear side of the occupant region of the cab of the work vehicle;
a rear valve fluidly coupled to the rear vent assembly, wherein the rear valve is configured to control the rear airflow through the rear vent assembly;
an air distribution system fluidly coupled to the first front valve and to the rear valve, wherein the air distribution system is configured to receive an input airflow from an inlet to the air distribution system and to direct the input airflow to the first front valve and to the rear valve;
at least one sensor configured to output at least one signal indicative of a position of the sun relative to the work vehicle; and
a controller communicatively coupled to the first front valve, the rear valve, and the at least one sensor, wherein the controller is configured to control the first front valve and the rear valve based at least in part on the at least one signal.

9. The airflow control system of claim 8, comprising a blower fluidly coupled to the inlet of the air distribution system, wherein the blower is configured to provide the input airflow to the air distribution system.

10. The airflow control system of claim 8, wherein the at least one sensor comprises:
a front sensor positioned forward of the front side of the occupant region relative to a direction of travel of the work vehicle, wherein the front sensor is configured to output a first signal indicative of the position of the sun relative to the work vehicle; and
a rear sensor positioned rearward of the rear side of the occupant region relative to the direction of travel of the work vehicle, wherein the rear sensor is configured to output a second signal indicative of the position of the sun relative to the work vehicle.

11. The airflow control system of claim 8, comprising:
a second front vent assembly configured to direct a second front airflow toward the front side of the occupant region of the cab; and
a second front valve fluidly coupled to the second front vent assembly, wherein the second front valve is configured to control the second front airflow through the second front vent assembly;
wherein the air distribution system is fluidly coupled to the second front valve, the air distribution system is configured to direct the input airflow from the inlet of the air distribution system to the second front valve, the controller is communicatively coupled to the second front valve, and the controller is configured to control the second front valve based at least in part on the at least one signal.

12. The airflow control system of claim 8, wherein the controller is configured to instruct the first front valve to increase the first front airflow and to instruct the rear valve to decrease the rear airflow while the sun is positioned on a front side of the work vehicle relative to a direction of travel of the work vehicle, and the controller is configured to instruct the first front valve to decrease the first front airflow and to instruct the rear valve to increase the rear airflow while the sun is positioned on a rear side of the work vehicle relative to the direction of travel.

13. The airflow control system of claim 8, comprising:
a left vent assembly configured to direct a left airflow toward a left side of the occupant region of the cab;
a left valve fluidly coupled to the left vent assembly, wherein the left valve is configured to control the left airflow through the left vent assembly;
a right vent assembly configured to direct a right airflow toward a right side of the occupant region of the cab; and
a right valve fluidly coupled to the right vent assembly, wherein the right valve is configured to control the right airflow through the right vent assembly;
wherein the air distribution system is fluidly coupled to the left valve and to the right valve, the air distribution system is configured to direct the input airflow from the inlet of the air distribution system to the left valve and to the right valve, the controller is communicatively coupled to the left valve and to the right valve, and the controller is configured to control the left valve and the right valve based at least in part on the at least one signal.

14. The airflow control system of claim 13, wherein the controller is configured to instruct the left valve to increase the left airflow and to instruct the right valve to decrease the right airflow while the sun is positioned on a left side of the work vehicle relative to a direction of travel of the work vehicle, and the controller is configured to instruct the left valve to decrease the left airflow and to instruct the right valve to increase the right airflow while the sun is positioned on a right side of the work vehicle relative to the direction of travel.

15. The airflow control system of claim 8, comprising an airflow control assembly fluidly coupled to the inlet of the air distribution system, wherein the airflow control assembly is configured to control mixing of external air from an external environment and recirculated air from the cab of the work vehicle based on a position of a door of the airflow control assembly, the controller is communicatively coupled to the airflow control assembly, and the controller is configured to instruct the airflow control assembly to control the position of the door to substantially maintain a flow rate of the external air into the air distribution system while the controller controls the first front valve and the rear valve based at least in part on the at least one signal.

16. An airflow control system of a work vehicle, comprising:
a first front vent assembly configured to direct a first front airflow toward a front side of an occupant region of a cab of the work vehicle;
a first front blower configured to receive an input airflow and to provide the first front airflow to the first front vent assembly;
a rear vent assembly configured to direct a rear airflow toward a rear side of the occupant region of the cab of the work vehicle;
a rear blower configured to receive the input airflow and to provide the rear airflow to the rear vent assembly;
an airflow control assembly configured to control a flow rate of external air from an external environment into the input airflow by adjusting a position of a door that controls mixing of the external air and recirculated air from an interior of the cab;
at least one sensor configured to output at least one signal indicative of a position of the sun relative to the work vehicle; and
a controller communicatively coupled to the airflow control assembly, the first front blower, the rear blower, and the at least one sensor, wherein the controller is configured to control the first front blower and the rear blower based at least in part on the at least one signal, and the controller is configured to instruct the airflow control assembly to control the position of the door to substantially maintain the flow rate of the external air into the input airflow while the controller controls the first front blower and the rear blower based at least in part on the at least one signal.

17. The airflow control system of claim 16, wherein the at least one sensor comprises:
a front sensor positioned forward of the front side of the occupant region relative to a direction of travel of the work vehicle, wherein the front sensor is configured to output a first signal indicative of the position of the sun relative to the work vehicle; and
a rear sensor positioned rearward of the rear side of the occupant region relative to the direction of travel of the work vehicle, wherein the rear sensor is configured to output a second signal indicative of the position of the sun relative to the work vehicle.

18. The airflow control system of claim 16, comprising:
a second front vent assembly configured to direct a second front airflow toward the front side of the occupant region of the cab; and
a second front blower configured to receive the input airflow and to provide the second front airflow to the second front vent assembly;
wherein the controller is communicatively coupled to the second front blower, and the controller is configured to control the second front blower based at least in part on the at least one signal.

19. The airflow control system of claim 16, wherein the controller is configured to instruct the first front blower to increase capacity and to instruct the rear blower to decrease capacity while the sun is positioned on a front side of the work vehicle relative to a direction of travel of the work vehicle, and the controller is configured to instruct the first front blower to decrease capacity and to instruct the rear blower to increase capacity while the sun is positioned on a rear side of the work vehicle relative to the direction of travel.

20. The airflow control system of claim 16, comprising:
a left vent assembly configured to direct a left airflow toward a left side of the occupant region of the cab;
a left blower configured to receive the input airflow and to provide the left airflow to the left vent assembly;
a right vent assembly configured to direct a right airflow toward a right side of the occupant region of the cab; and
a right blower configured to receive the input airflow and to provide the right airflow to the right vent assembly;
wherein the controller is communicatively coupled to the left blower and to the right blower, and the controller is configured to control the left blower and the right blower based at least in part on the at least one signal.
